(19) United States
(12) Patent Application Publication
(10) Pub. No.: US 2003/0174138 A1
(43) Pub. Date: Sep. 18, 2003

(54) Image display circuitry and mobile electronic device

(76) Inventor: Hiroaki Shibayama, Shizuoka (JP)

Correspondence Address: YOUNG & THOMPSON, 745 SOUTH 23RD STREET 2ND FLOOR, ARLINGTON, VA, 22202

(21) Appl. No.: 10/365,518

(22) Filed: Feb. 13, 2003

(30) Foreign Application Priority Data
Feb. 13, 2002 (JP) 2002-035136

(51) Int. Cl. G09G 5/36

(52) U.S. Cl. 345/545

(57) ABSTRACT

An image display circuitry comprises frame buffers 32-34 for storing image data DTAW, DTRW and logical combining data DTCW respectively, and a combining circuit 46. Data buses and address buses of the frame buffers 32 and 34 are time-sharingly controllable from an MPU independently of those of the frame buffer 33. Each frame of the image data DTRW is synchronized with a vertical synchronizing signal, and stored to the frame buffer 33. Each frame of the image data DTAW and the logical combining data DTCW is separately and independently stored to the frame buffers 32 and 34 by the MPU within a storage period of a corresponding frame of the image data DTRW. The combining circuit 46 combines image data DTAR and DTBR pixel by pixel on the basis of logical combining data DTCR within a specified period during a vertical retrace period.

### BACKGROUND OF THE INVENTION

1. Field of the Invention

The present invention relates to an image display circuitry and a mobile electronic device. In particular, it relates to an image display circuitry for combining displays of characters, images and the like to be displayed on a display, which constitutes a mobile electronic device such as a notebook/palm/pocket computer, personal digital assistant (PDA), mobile phone, personal handy-phone system (PHS), or the like, and to a mobile electronic device to which such an image display circuitry is applied.

2. Description of the Related Art

FIG. 1 is a block diagram showing one example of a configuration of a conventional graphics display device disclosed in Japanese unexamined patent publication No. 63-178294.

The graphics display device of this example comprises a microprocessor unit (MPU) 1, a memory 2, an interface control unit 3, a bus 4, frame buffers 5-7, registers 8-10, a storage control circuitry 11, dot shifters 12-14, color palettes 15 and 16, a display combining circuitry 17, a digital-analog converter (DAC) 18, a display synchronization circuitry 19, and a CRT display unit 20. The MPU 1, the memory 2, the interface control unit 3, the frame buffers 5 and 6, the registers 8-10, and the display synchronization circuitry 19 are connected via the bus 4.

By executing a program stored in the memory 2, the MPU 1 interprets a graphics display command supplied from a host device such as a personal computer, and develops display information into a pixel pattern, and stores it in the buffer 5 or 6. The memory 2 stores the programs and data to be executed by the MPU 1. The interface control unit 3 controls the interface between the host device and this graphics display device. The frame buffer 5 is a multiplane memory for storing display pixel information in color code format in which each plane corresponds to 1 bit, and data words during drawing are formed in pixel direction. For instance, in order to enable display performance of 2^{P} colors simultaneously representable at display resolution of M pixels×N lines (M, N, and P are natural numbers), the frame buffer 5 is required comprising P planes with a memory capacity of at least (M×N) bits. The frame buffer 6 is a multiplane memory for storing display pixel information in color code format in which each plane corresponds to 1 bit, and data words during drawing are formed in plane direction. For instance, to enable display performance of 2^{Q} colors simultaneously representable at display resolution of M pixels×N lines (M, N, and Q are natural numbers), the frame buffer 6 is required comprising Q planes with a memory capacity of at least (M×N) bits. The frame buffer 7 is a single plane memory for storing, pixel by pixel, logical combining information for combining the display pixel information stored in the frame buffers 5 and 6, and has a memory capacity of (M×N) bits.

The register 8 stores data to be stored to the frame buffer 7. The register 9 stores a start address when the data stored in the register 8 is stored to the frame buffer 7. The register 10 stores an end address when the data stored in the register 8 is stored to the frame buffer 7. The storage control circuitry 11 generates a control signal for storing the data stored in the register 8 in an address range designated by the start address stored in the register 9 and by the end address stored in the register 10. The dot shifters 12-14 are provided corresponding to the frame buffers 5-7 respectively, and convert parallel display pixel information or logical combining information read from the respectively corresponding frame buffers 5-7 into serial pixel information. The color palettes 15 and 16 are provided corresponding to the dot shifters 12 and 13 respectively, and are table memories for outputting color tone data, where the serial pixel information output from the respectively corresponding dot shifters 12 and 13 is address information. The color palette 15 has 2^{P+1} entries, and the color palette 16 has 2^{Q+1} entries.

The display combining circuitry 17 combines the display pixel information stored in the frame buffers 5 and 6 by performing, pixel by pixel, logical operations of the color tone data output from the color palettes 15 and 16, on the basis of the pixel information output from the dot shifter 14. The DAC 18 converts the digital color tone data output from the display combining circuitry 17 into an analog video signal. The display synchronization circuitry 19 generates a synchronizing signal for displaying the video signal output from the DAC 18 on the CRT display unit 20, while controlling the reading of the display pixel information or logical combining information from the frame buffers 5-7. The CRT display unit 20 controls deflection on the basis of the synchronizing signal supplied from the display synchronization circuitry 19, and displays the video signal output from the DAC 18 on the CRT display unit 20.

FIG. 2 illustrates one example of relationships between display pixel information A, B and logical combining information C stored in each frame buffer 5-7, and a picture D displayed on the CRT display, in which the data of the frame buffer 7 is defined at logic “0” as a frame buffer 5 display, and at logic “1” as a frame buffer 6 display.

Such a structure makes it possible to designate an address range of the logical combining information stored to the frame buffer 7, and reduces the burden of MPU 1 controlling display combining, and consequently improves drawing performance.

Nowadays, of mobile electronic devices such as notebook/palm/pocket computers, personal digital assistants (PDA), mobile phones, personal handy-phone systems (PHS), or the like, there are mobile electronic devices with a built-in digital camera, which combine and display on a liquid crystal panel display or the like, static and moving images transmitted from outside, static and moving images taken by the built-in digital camera, and internal information of the mobile electronic device, such as information of battery level, antenna reception and the like.

In mobile electronic devices of this kind, an MPU used for controlling each portion of the mobile electronic device cannot have high processing performance and high power consumption because of the requirements of miniaturization, low cost, and low power consumption.

Accordingly, the technique for the conventional graphics display device, which is aimed at combining and displaying on a CRT display images supplied from a host device such as a personal computer, cannot be applied directly to the mobile electronic device, because in graphics display devices of this kind, the processing performance and power consumption of the MPU 1 are not particularly restricted.

Also, as seen from FIG. 1, in the above-described conventional graphics display device, access to the frame buffers 5 and 6 must be via the bus 4, and likewise access to the frame buffer 7 must be via the bus 4 and the registers 8-10. Furthermore, image data supply to this graphics display device from an electronic device other than the host device, for example, from a camera, must be via the interface control unit 3. Therefore, if the host device occupies the interface control unit 3 and the bus 4 and supplies image data, or if the MPU 1 occupies the bus 4 and performs each kind of processing, then the camera image data cannot be supplied to the frame buffer 5 or 6. Consequently, the conventional graphics display device has the drawback of being unable to combine in real time and display on the CRT display unit 20 the camera image data and the other image data.

Further, above-described Japanese unexamined patent publication No. 63-178294 does not in any way disclose concrete timing of image combining. Therefore, the technique disclosed in the above-described publication does not in any way suggest concretely how to enable image combining.

### SUMMARY OF THE INVENTION

Thus, an object of the present invention is to provide an image display circuitry and a mobile electronic device capable of combining in real time and displaying on a display each kind of image even though an MPU with not high processing performance is used in the mobile electronic device.

In order to solve the above problems, an image display circuitry of the present invention comprises a first frame buffer for storing first image data; a second frame buffer for storing second image data supplied from a camera; a third frame buffer for storing logical combining data to be used for combining the first and second image data pixel by pixel; and a combining circuit for combining the first and second image data by use of the logical combining data; wherein: a data bus and an address bus, each of which is connected to the first and third frame buffers, are separate and independent of a data bus and an address bus which are connected to the second frame buffer; the data bus and the address bus, each of which is connected to the first and third frame buffers, are time-sharingly controllable from outside independently of the data bus and the address bus which are connected to the second frame buffer; and the first and second image data and the logical combining data are time-sharingly stored and combined in the combining circuit, for one frame within one period of a vertical synchronizing signal for the second image data.

In the above-described image display circuitry of the present invention, each frame of the second image data is synchronized with a vertical synchronizing signal for the second image data, and stored to the second frame buffer; each frame of the first image data and the logical combining data is separately and independently stored from outside to the respective first and third frame buffers within a period of storing a corresponding frame of the second image data to the second frame buffer; and the combining circuit combines, pixel by pixel, the first and second image data read from the respective first and second frame buffers by use of the logical combining data read from the third frame buffer within a specified period during a vertical retrace period of the vertical synchronizing signal.

In the above-described image display circuitry of the present invention, the combining circuit combines one of the first and second image data with the other as a telop picture of a static or moving image.

In the above-described image display circuitry of the present invention, the combining circuit combines one of the first and second image data with the other as a wipe picture that wipes a picture from one corner and immediately displays a next picture.

The above-described image display circuitry of the present invention further comprises a color increasing circuit for increasing a color of the first image data read from the first frame buffer to a color displayable on a display, and then supplying its processed result to the combining circuit; and a color decreasing circuit for decreasing a color of the second image data read from the second frame buffer to a color displayable on the display, and then supplying its processed result to the combining circuit.

The above-described image display circuitry of the present invention further comprises a conversion circuit for converting the second image data supplied from the camera into third image data of a form displayable on a display; and a first reduction circuit for reducing a pixel number of the third image data to a display pixel number of the display.

In the above-described image display circuitry of the present invention, the first reduction circuit performs smart processing in reducing the third image data in a line, wherein values of adjacent image data are computed, and its computed result is divided into two.

The above-described image display circuitry of the present invention further comprises a second reduction circuit for reducing the second image data supplied from the camera to fourth image data compressible into image data of JPEG form; and a compression circuit for compressing the fourth image data into image data of the JPEG form, and then storing it to the first to third frame buffers that are treated as a single whole frame buffer.

In the above-described image display circuitry of the present invention, the second reduction circuit performs smart processing in reducing the fourth image data in a line, wherein values of adjacent image data are computed, and its computed result is divided into two.

The above-described image display circuitry of the present invention further comprises a filtering circuit for performing any one of the following filterings on the second image data supplied from the camera: sepia, brightness adjustment, grey scale, tone binarization, edge enhancement, edge extraction.

A mobile electronic device comprises the above-described image display circuitry; a camera for supplying the second image data to the image display circuitry; and a display for displaying image data supplied from the image display circuitry.

In the above-described mobile electronic device, the first image data is any of: static image data; moving image data; illustration data; animation data; static/moving image data for a frame for decorating a periphery of the second image data; a waiting picture displayed while waiting for incoming data without any operation by a user although with the device powered on; a screen saving picture displayed for preventing burning in after the waiting picture is displayed for a specified time; a game picture.

In the above-described mobile electronic device, the screen saving picture is an animation pattern, a pattern with which characters that are changed according to season move freely around in a display screen.

In the above-described mobile electronic device, the game picture is a character raising game for raising selected characters by a user feeding or cherishing them.

A mobile electronic device comprises a camera for generating image data to be displayed; a circuit for processing the image data supplied from the camera to provide processed image data, and generating an address signal to determine a storage address of the processed image data; a frame buffer for storing the processed image data at the storage address; a data bus for transferring the processed image data from the processing circuit to the frame buffer; and a display for displaying an image by use of the processed image data read from the frame buffer.

In the above-described mobile electronic device, the frame buffer comprises: a first storage region for storing image data supplied from an MPU; a second storage region for storing the processed image data; and a third storage region for storing data to be used for combining the image data read from the first and second storage regions; wherein the display displays an image obtained from combining the image data read from the first and second storage regions by use of the data read from the third storage region.

The above-described mobile electronic device further comprises a data bus for transferring the image data from the MPU to the first memory region of the frame buffer.

In the above-described mobile electronic device, the processing circuit comprises a filtering circuit for filtering the image data supplied from the camera; a first reduction circuit for reducing the image data filtered by the filtering circuit to image data compressible into JPEG form; and a compression circuit for compressing the image data reduced by the first reduction circuit into image data of the JPEG form.

In the above-described mobile electronic device, the processing circuit comprises a filtering circuit for filtering the image data supplied from the camera; a conversion circuit for converting the image data filtered by the filtering circuit into image data of a form displayable on the display; and a second reduction circuit for reducing a pixel number of the image data converted by the conversion circuit to a display pixel number of the display.

In the above-described mobile electronic device, the processing circuit comprises: a filtering circuit for filtering the image data supplied from the camera; a first reduction circuit for reducing the image data filtered by the filtering circuit to image data compressible into JPEG form; a compression circuit for compressing the image data reduced by the first reduction circuit into image data of the JPEG form; a conversion circuit for converting the image data filtered by the filtering circuit into image data of a form displayable on the display; and a second reduction circuit for reducing a pixel number of the image data converted by the conversion circuit to a display pixel number of the display.

According to the present invention, an image display circuitry comprises a first frame buffer for storing first image data, a second frame buffer for storing second image data supplied from a camera, a third frame buffer for storing logical combining data to be used for combining the first and second image data pixel by pixel, and a combining circuit for combining the first and second image data by use of the logical combining data. Also, a data bus and an address bus, each of which is connected to the first and third frame buffers, are separate and independent of a data bus and an address bus which are connected to the second frame buffer, and the data bus and the address bus, each of which is connected to the first and third frame buffers, are time-sharingly controllable from outside independently of the data bus and the address bus which are connected to the second frame buffer. Each frame of the second image data is synchronized with a vertical synchronizing signal for the second image data, and stored to the second frame buffer. Each frame of the first image data and logical combining data is separately and independently stored to the respective first and third frame buffers within a period of storing a corresponding frame of the second image data to the second frame buffer. The combining circuit combines, pixel by pixel, the first and second image data read from the respective first and second frame buffers by use of the logical combining data read from the third frame buffer within a specified period during a vertical retrace period of the vertical synchronizing signal.

Thus, even though a microprocessor with not high processing performance is used in a mobile electronic device to which the above image display circuitry is applied, each kind of image can, in real time, be combined and displayed on a display.

### BRIEF DESCRIPTION OF THE DRAWINGS

A preferred embodiment of the present invention will hereinafter be described with reference to the accompanying drawings, wherein:

FIG. 1 is a block diagram showing a configuration example of a conventional graphics display device.

FIG. 2 is a diagram illustrating one example of relationships between display pixel information A, B and logical combining information C stored in frame buffers 5-7 that constitute the graphics display device of FIG. 1, and a picture D displayed on a CRT display.

FIG. 3 is a block diagram showing a configuration of an image display circuitry 21 of one embodiment of the present invention.

FIG. 4 is a block diagram showing a configuration of a mobile phone to which the same circuitry 21 is applied.

FIG. 5 is a timing chart for explaining the operation of the same circuitry 21.

FIG. 6 is a timing chart for explaining the operation of the same circuitry 21.

FIG. 7 is a timing chart for explaining the operation of the same circuitry 21.

FIG. 8 is a timing chart for explaining the operation of the same circuitry 21.

FIG. 9 is a diagram illustrating one example of relationships between image data A, B and logical combining data C stored in frame buffers 32-34 that constitute the same circuitry 21, and a picture D displayed on a display.

FIG. 10 is a diagram showing one example of combined moving images displayed on the display.

FIG. 11 is a diagram illustrating one example of relationships between moving image data A, B and logical combining data C stored in frame buffers 32-34 that constitute the same circuitry 21, and a moving picture D displayed on a display.

FIG. 12 shows a schematic diagram of a sequence of the processings shown in FIG. 11 performed with time.

FIG. 13 is a block diagram showing a mobile electronic device in a preferred embodiment of the present invention in which FIG. 13 is illustrated by simplifying FIG. 3 and partially combining FIG. 4 therewith.

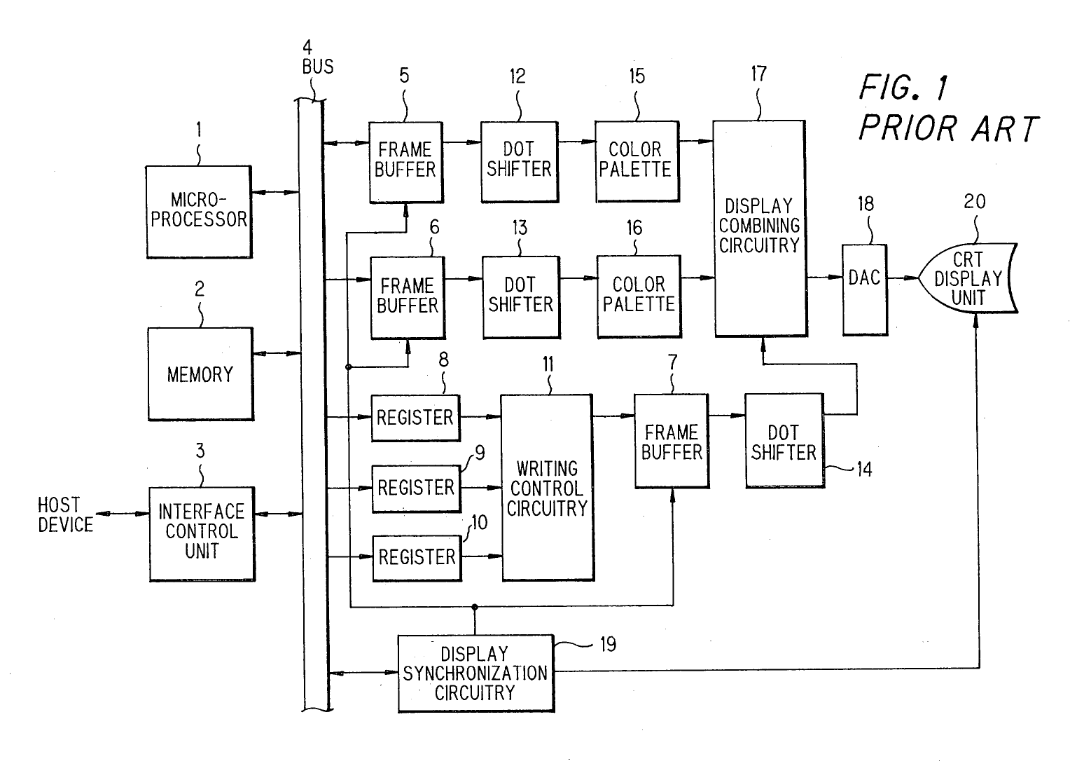

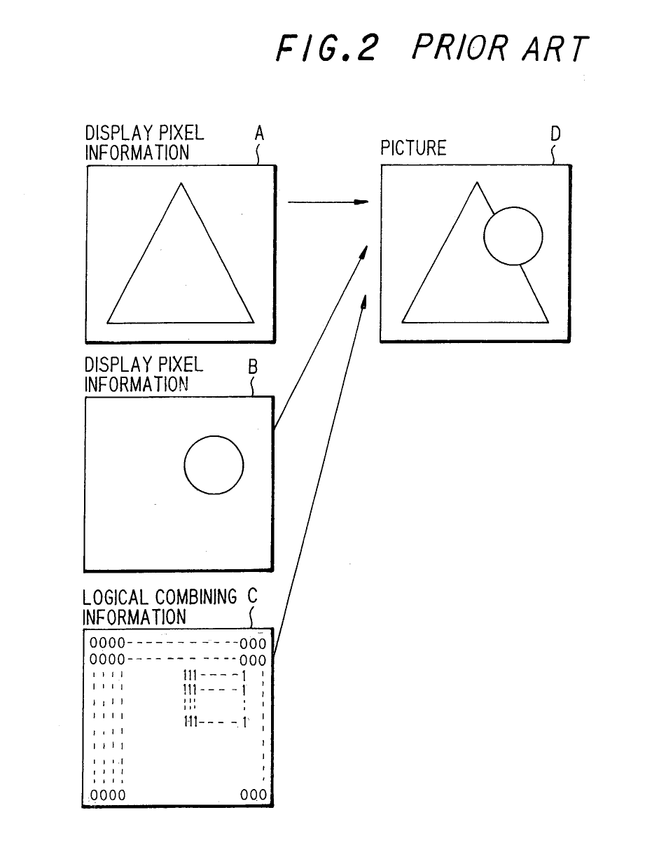

### DETAILED DESCRIPTION OF THE PREFERED EMBODIMENTS

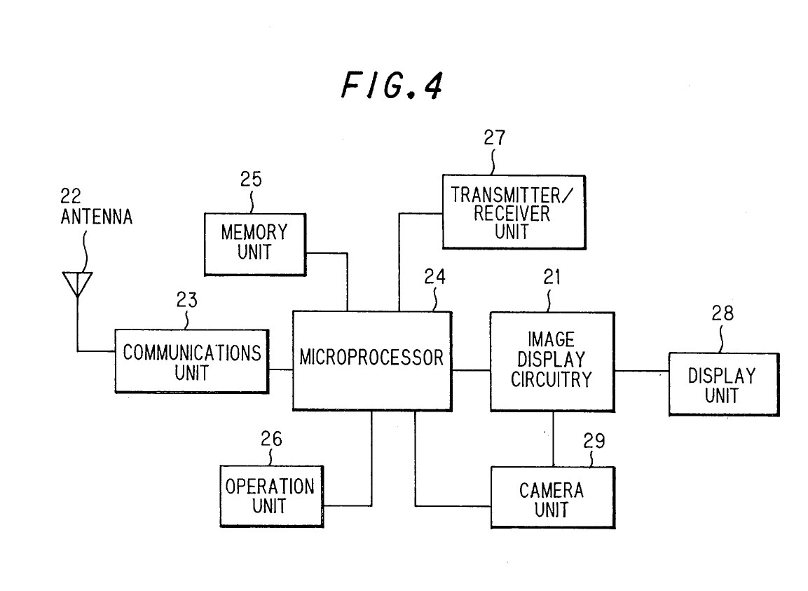

FIG. 4 is a block diagram showing a configuration of a mobile phone to which an image display circuitry 21 of one embodiment of the present invention is applied.

A mobile phone 1 of this embodiment generally comprises an image display circuitry 21, an antenna 22, a communications unit 23, an MPU 24, a memory unit 25, an operation unit 26, a transmitter/receiver unit 27, a display unit 28, and a camera unit 29.

The image display circuitry 21 comprises a semiconductor integrated circuit such as a large-scale integrated circuit (LSI), and combines and displays on the display unit 28 static and moving image data supplied from the MPU 24, static and moving image data taken by the camera unit 29, and internal information of the mobile phone, such as information of battery level, antenna reception and the like. A radio phone signal transmitted from a base station or an interior installed base phone (both not shown) is received by the communications unit 23 via the antenna 22, and is demodulated into an aural signal, static and moving image data, communications data, or control signal, and supplied to the MPU 24. Also, an aural signal, static and moving image data, communications data, or control signal supplied from the MPU 24 is modulated by the communications unit 23 into a radio phone signal, and transmitted via the antenna 22 to the above-mentioned base station or base phone.

Not only does the MPU 24 execute each kind of program stored in the memory unit 25 and control each portion of the mobile phone, but it also uses a control signal supplied from the communications unit 23 for the internal processing of the MPU 24. Also, not only does the MPU 24 process and supply an aural signal supplied from the communications unit 23 to the transmitter/receiver unit 27, but it also processes and supplies an aural signal supplied from the transmitter/receiver unit 27 to the communications unit 23. Furthermore, not only does the MPU 24 process and supply static and moving image data supplied from the communications unit 23 to the image display circuitry 21, but it also processes and supplies static and moving image data supplied from the camera unit 29 to the communications unit 23. The memory unit 25 comprises semiconductor memories such as ROM, RAM and the like, and stores each kind of program executed by the MPU 24 and each kind of data such as phone numbers set by a user operating the operation unit 26.

The operation unit 26 comprises numeric keypads used for the input of phone numbers and the like, and each kind of button for indicating phone call permission, phone call completion, display switching, present date modification, or the like. The transmitter/receiver unit 27 comprises a speaker and a microphone. The transmitter/receiver unit 27 is used for phone calls and the like, thereby not only emitting voices from the speaker on the basis of an aural signal supplied from the MPU 24, but also supplying an aural signal converted from voices by the microphone to the MPU 24. The display unit 28 comprises a display such as a liquid crystal panel, organic electroluminescence panel or the like, and a drive circuit for driving it. In this embodiment, the display is a liquid crystal panel, and its display screen has 120 lines and 160 pixels/line, and the pixel number of the whole display screen is 19,200. On the display unit 28, internal information of the mobile phone, such as information of battery level, antenna reception and the like, phone numbers, electronic mails, images attached to transmitted/received electronic mails, images showing contents supplied from WWW servers, images taken by the camera unit 29, are displayed. The camera unit 29 comprises a digital camera and a drive circuit for driving it, and is fitted to a chassis of the mobile phone, and supplies 30 frames/second image data to the image display circuitry 21 or the MPU 24.

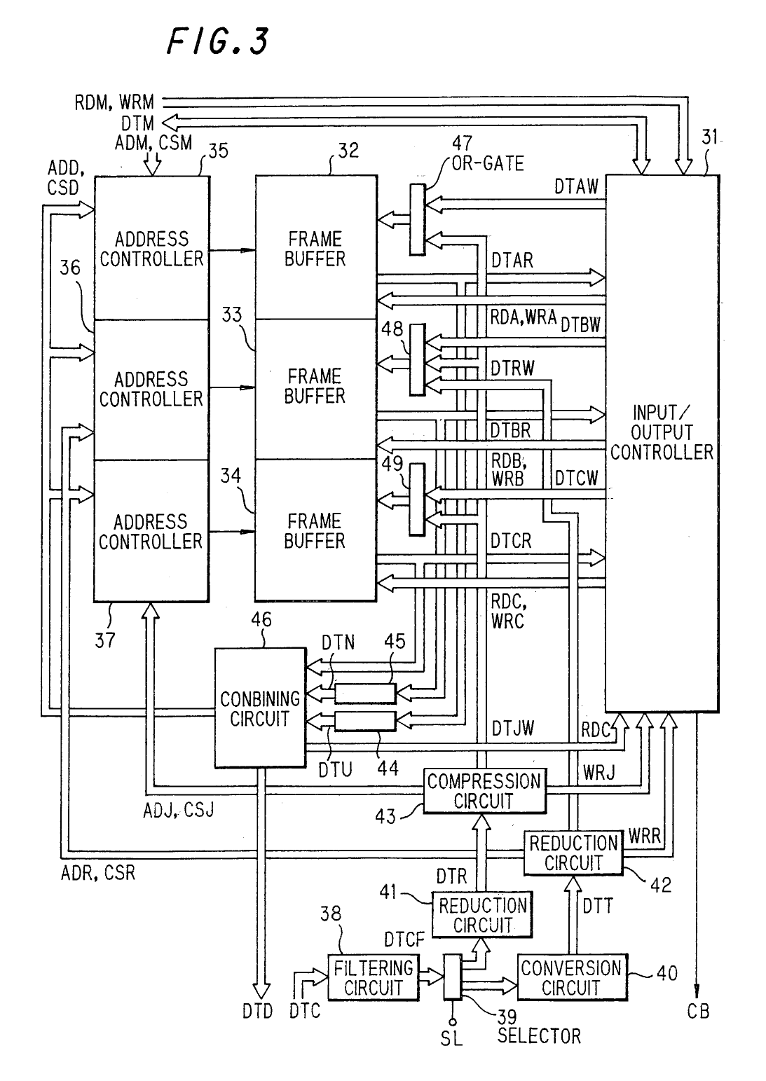

Next, a configuration of the image display circuitry 21 of this embodiment will be described with reference to FIG. 3.

The image display circuitry 21 comprises an input/output controller 31, frame buffers 32-34, address controllers 35-37, a filtering circuit 38, a selector 39, a conversion circuit 40, reduction circuits 41 and 42, a compression circuit 43, a color increasing circuit 44, a color decreasing circuit 45, a combining circuit 46, and OR gates 47-49.

The input/output controller 31 transfers data DTM between it and the MPU 24 on the basis of a read command RDM and a write command WRM supplied from the MPU 24. Also, not only does the input/output controller 31 supply read commands RDA, RDB, RDC to the frame buffers 32-34 and read therefrom image data DTAR, DTBR and logical combining data DTCR, but it also supplies write commands WRA, WRB, WRC to the frame buffers 32-34 and stores therein image data DTAW, DTBW and logical combining data DTCW via the OR gates 47-49. Here, the logical combining data DTCW is data for combining the image data DTAW stored in the frame buffer 32 and the display pixel information DTBW stored in the frame buffer 33. Furthermore, on the basis of a write command WRR supplied from the reduction circuit 42, the input/output controller 31 permits writing image data DTRW supplied from the reduction circuit 42 to the frame buffer 33 via the OR gate 48. Also, on the basis of a write command WRJ supplied from the compression circuit 43, the input/output controller 31 permits writing compressed image data DTJW supplied from the compression circuit 43 to the frame buffers 32-34 via the respective OR gates 47-49. In this case, the frame buffers 32-34 are treated as a single whole frame buffer. Also, on the basis of a read command RDC supplied from the combining circuit 46, the input/output controller 31 reads image data DTAR, DTBR and logical combining data DTCR from the respective frame buffers 32-34, and supplies them to the color increasing circuit 44, the color decreasing circuit 45, and the combining circuit 46, respectively. Furthermore, the input/output controller 31 supplies, to the camera unit 29, a busy signal CB that indicates currently accessing the frame buffer 33.

The frame buffer 32 comprises a VRAM with a memory capacity of 19.2 kbytes, and stores therein red data R (3 bits), green data G (3 bits), and blue data B (2 bits) making 256 colors simultaneously representable. This frame buffer 32 is used mainly for producing animated moving image data, a waiting picture displayed while waiting for incoming data without any operation by a user although with the mobile phone powered on, and a menu picture displayed when a user selects each kind of function of the mobile phone. The frame buffer 33 comprises a VRAM with a memory capacity of 38.4 kbytes, and stores therein red data R (5 bits), green data G (6 bits), and blue data B (5 bits) making 65,536 colors simultaneously representable. This frame buffer 33 is used mainly for producing static image data such as photographic data. The frame buffer 34 comprises a VRAM with a memory capacity of 2.4 kbytes, and stores therein, pixel by pixel, logical combining data for combining image data stored in the frame buffer 32 and image data stored in the frame buffer 33.

Also, the frame buffers 32-34 are treated as a single whole frame buffer if image data is stored in JPEG (joint photographic experts group) form. Here, the JPEG form refers to an image file form that uses a static image compression/expansion method standardized by the joint organization of the ISO (International Standardization Organization) and the ITU-T (International Telecommunication Union-Telecommunication Standardization Sector) that advance the standardization of a method of encoding color static image data. This JPEG form is a format suited to store natural images, such as photographs, whose tones change continuously. By exploiting human eye sensibility to a brightness change and relative insensitivity to a color change, the JPEG form thins out color data to enhance the compression rate of data. By altering the compression rate of data, the JPEG form can compress the size of static image data to 1/10-1/100, and thus is used for file form of storing images in most of present digital cameras.

The address controllers 35-37 are provided corresponding to the frame buffers 32-34 respectively, and are activated by a chip select signal CSM supplied from the MPU 24, and designate a storage region of image data to be stored to or to be read from the corresponding frame buffers on the basis of an address ADM supplied from the MPU 24. Also, if image data is stored in JPEG form to the frame buffers 32-34, the address controllers 35-37 are treated as a single whole address controller, and are activated by a chip select signal CSJ supplied from the compression circuit 43, and designate a storage region of image data to be stored in the corresponding frame buffers on the basis of an address ADJ supplied from the compression circuit 43. Furthermore, the address controllers 35-37 are activated by a chip select signal CSD supplied from the combining circuit 46, and designate a storage region of image data to be read from the corresponding frame buffers on the basis of an address ADD supplied from the combining circuit 46. Also, the address controller 36 is activated by a chip select signal CSR supplied from the reduction circuit 42, and designates a storage region of image data to be stored on the basis of an address ADR supplied from the reduction circuit 42.

The filtering circuit 38 performs each kind of filtering on image data DTC supplied from the camera unit 29, and outputs image data DTCF. As examples of each kind of filtering, there are sepia, brightness adjustment, grey scale, tone binarization, edge enhancement, edge extraction (binarization), and the like. The image data DTC is expressed in YUV form that represents colors with 3 kinds of information: brightness data Y, difference data U between brightness data Y and red data R, and difference data V between brightness data Y and blue data B. By exploiting human eye sensibility to a brightness change more than to a color change, the YUV form can assign more amounts of data to brightness information to attain the high compression rate of data with less image deterioration, but requires converting image data into RGB form in order to display it on the display unit 28. Shown below are conversion equations between red data R, green data G, blue data B of image data of RGB form, and brightness data Y, difference data U, V of image data of YUV form. In this embodiment, the image data DTC is brightness data Y of 4 bits, and difference data U and V of 2 bits each, i.e. 8 bits in total.

Y=R×0.299+G×0.587+B×0.114 (1)

U=0.654×(B−Y)+128=−R×0.168−G×0.331+B×0.500+128 (2)

V=0.713×(R−Y)+128=R×0.500−G×0.419−B×0.081+128 (3)

If select data SL supplied from the camera unit 29 is logic “0”, then the selector 39 supplies the image data DTCF supplied from the filtering circuit 38 to the conversion circuit 40, and if the select data SL is logic “1”, then the selector 39 supplies the image data DTCF supplied from the filtering circuit 38 to the reduction circuit 41. With the use of the above conversion equations (1)-(3), the conversion circuit 40 converts the image data of YUV form (4-bit brightness data Y, 2-bit difference data U, 2-bit difference data V) supplied from the selector 39 into image data DTT of RGB form (5-bit red data R, 6-bit green data G, 5-bit blue data B). The reduction circuit 41 reduces the image data DTCF of YUV form (4-bit brightness data Y, 2-bit difference data U, 2-bit difference data V) supplied from the selector 39 to image data DTR. In this reduction, the image data DTCF supplied from the selector 39 is thinned out every other line and every other pixel in a line, so that the height and width of a picture are reduced to ½, and its area is reduced to ¼. Also, in thinning every other pixel in a line, values of adjacent image data are computed, and its computed result is divided into two to perform smart processing so that oblique lines are not stepwise.

The reduction circuit 42 thins out the image data DTT supplied from the conversion circuit 40 every other two lines and every other two pixels in a line, so that the height and width of a picture are reduced to ¼, and its area is reduced to 1/16. In this case, the reduction circuit 42 also performs the above-mentioned smart processing on the image data DTT. Also, in order to store the reduced image data DTRW in a specified storage region of the frame buffer 33, the reduction circuit 42 supplies the image data DTRW to the OR gate 48 while supplying a write command WRR to the input/output controller 31, and an address ADR and a chip select signal CSR to the address controller 36. In order to make the image data DTR supplied from the reduction circuit 41 into the above-described JPEG form, the compression circuit 43 performs specified compression on the image data DTR. Also, in order to store the compressed image data DTJW in a specified storage region of the frame buffers 32-34 treated as a single whole frame buffer, the compression circuit 43 supplies the image data DTJW to the OR gates 47-49 while supplying a write command WRJ to the input/output controller 31, and an address ADJ and a chip select signal CSJ to the address controllers 35-37 treated as a single whole address controller.

The color increasing circuit 44 increases a color of the image data DTAR supplied from the frame buffer 32 so as to display it on a display (e.g. liquid crystal panel) that constitutes the display unit 28. Then, its processed result is supplied to the combining circuit 46 as image data DTU. The color decreasing circuit 45 decreases a color of the image data DTBR supplied from the frame buffer 33 so as to display it on a display (e.g. liquid crystal panel) that constitutes the display unit 28. Then, its processed result is supplied to the combining circuit 46 as image data DTN. The combining circuit 46 supplies a read command RDC to the input/output controller 31, and an address ADD and a chip select signal CSD to the address controllers 35-37, so that the image data DTAR, DTBR and logical combining data DTCR are read from specified storage regions of the frame buffers 32-34, respectively. And on the basis of the logical combining data DTCR supplied from the frame buffer 34, the combining circuit 46 combines the image data DTU supplied from the color increasing circuit 44 and the image data DTN supplied from the color decreasing circuit 45, and its combined result is supplied to the display unit 28 as image data DTD to be displayed on the display.

The OR gate 47 takes a logical addition of the image data DTAW supplied from the input/output controller 31 and the image data DTJW supplied from the compression circuit 43, and supplies it to the frame buffer 32. The OR gate 48 takes a logical addition of the image data DTBW supplied from the input/output controller 31, the image data DTRW supplied from the reduction circuit 42, and the image data DTJW supplied from the compression circuit 43, and supplies it to the frame buffer 33. The OR gate 49 takes a logical addition of the logical combining data DTCW supplied from the input/output controller 31 and the image data DTJW supplied from the compression circuit 43, and supplies it to the frame buffer 34.

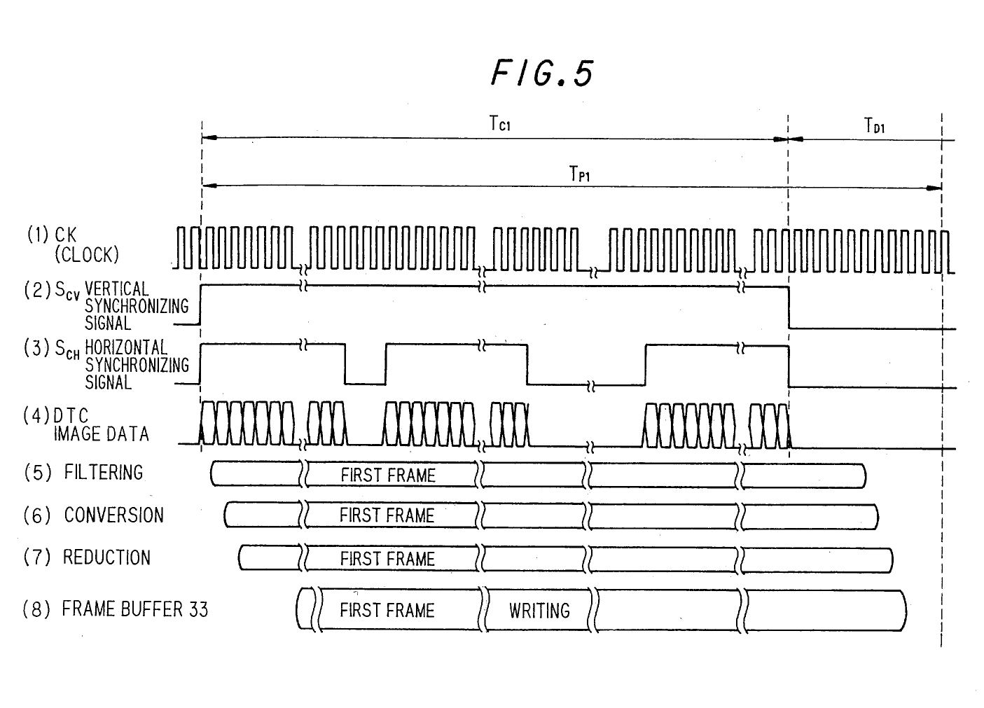

Next, operation of the above image display circuitry will be described with reference to the flowcharts shown in FIGS. 5-8. Note that in FIGS. 5-8, relative relationships of each data and signal in time axis are only matched. First, the camera unit 29 is synchronized with a clock CK shown in FIG. 5(1), and supplies a vertical synchronizing signal S_{CV} shown in FIG. 5(2), a horizontal synchronizing signal S_{CH}. shown in FIG. 5(3), and image data DTC shown in FIG. 5(4). In this embodiment, the image data DTC is of YUV form: brightness data Y of 4 bits, and difference data U and V of 2 bits each, i.e. 8 bits in total. Also, the camera unit 29 is called VGA (video graphics array), and has a resolution of 640×480 pixels, i.e. 640 pixels/line and 480 lines. Therefore, T_{C1} shown in FIG. 5 denotes a time for which first-frame image data DTC is supplied from the camera unit 29. Let T be a period of the clock CK, then the time T_{C1} is expressed as:

T_{C1}=T×640×480 (4)

And, it is assumed that the camera unit 29 supplies only 30 frames/second image data DTC.

Accordingly, within a time shown in FIG. 5(5), the filtering circuit 38 performs each kind of filtering described above, such as sepia, brightness adjustment or the like, on the first-frame image data DTC shown in FIG. 5(4), and outputs image data DTCF. In this case, if logic “0” select data SL (not shown in FIG. 5) is supplied from the camera unit 29, then the selector 39 supplies the image data DTCF supplied from the filtering circuit 38 to the conversion circuit 40. Accordingly, within a time shown in FIG. 5(6), with the use of the above conversion equations (1)-(3), the conversion circuit 40 converts the image data of YUV form (4-bit brightness data Y, 2-bit difference data U, 2-bit difference data V) of the first frame supplied from the selector 39 into image data DTT of RGB form (5-bit red data R, 6-bit green data G, 5-bit blue data B) of the first frame.

Within a time shown in FIG. 5(7), the reduction circuit 42 thins out the image data DTT of RGB form (5-bit red data R, 6-bit green data G, 5-bit blue data B) of the first frame supplied from the conversion circuit 40 every other two lines and every other two pixels in a line, so that the height and width of a picture are reduced to ¼, and its area is reduced to 1/16. Accordingly, image data DTRW output from the reduction circuit 42 has 160 pixels/line and 120 lines. That is, the pixel number of the image data DTRW is the same as that of the above-described liquid crystal panel. Also, in order to store the reduced image data DTRW in a specified storage region of the frame buffer 33, the reduction circuit 42 supplies the image data DTRW to the OR gate 48 while supplying a write command WRR to the input/output controller 31, and an address ADR and a chip select signal CSR to the address controller 36. Accordingly, on the basis of the write command WRR supplied from the reduction circuit 42, the input/output controller 31 permits writing the image data DTRW to the frame buffer 33 via the OR gate 48. Also, the address controller 36 is activated by the chip select signal CSR supplied from the reduction circuit 42, and designates a storage region of image data to be stored on the basis of the address ADR supplied from the reduction circuit 42. Accordingly, within a time shown in FIG. 5(8), the image data DTRW is written to the storage region of the frame buffer 33 designated by the address controller 36.

Also, T_{P1} shown in FIG. 5 denotes a time for performing first-frame image processing, and T_{D1} shown in FIG. 5 denotes a time for performing first-frame image data transfer to a display unit 28 and the like as will be described later.

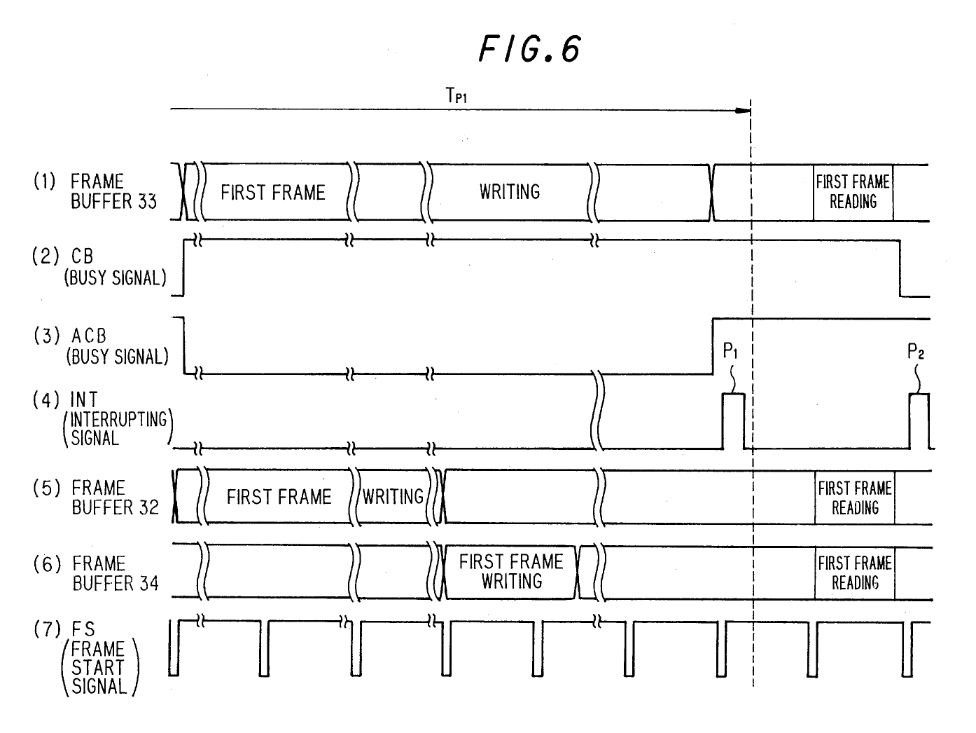

As described above, during the time T_{P1}, one-frame image data DTC is supplied from the camera unit 29 to the image display circuitry 21, and after the processings of filtering, conversion, and reduction, it is written to the frame buffer 33. In this embodiment, during the time T_{P1}, the MPU 24 freely accesses the frame buffers 32 and 34, so that illustration data and the like may be stored in the frame buffer 32, for example. That is, a data bus and an address bus, each of which is connected to the frame buffers 32-34, are separate and independent, and signals for controlling the frame buffers 32-34 are also separately and independently suppliable, and the bus interface between the frame buffers 32 and 34 is unitedly or independently and time-sharingly controllable by the MPU 24. Accordingly, as shown in FIG. 6(3), the input/output controller 31 supplies, to the MPU 24, a low active busy signal ACB which indicates that the image display circuitry 21 is currently accessing the frame buffer 33. The MPU 24 recognizes accessibility to the frame buffers 32 and 34 when the busy signal ACB becomes an “L” level.

Then, in the embodiment shown in FIG. 6, within a time shown in FIG. 6(5), the MPU 24 supplies, to the address controller 35, a chip select signal CSM and an address ADM corresponding to an image data storage region of the frame buffer 32. Also, the MPU 24 supplies, to the input/output controller 31, a write command WRM for requiring the writing of image data to the frame buffer 32, and image data DTM to be stored to the frame buffer 32. Accordingly, the address controller 35 is activated by the chip select signal CSM supplied from the MPU 24, and designate a storage region of the image data to be stored in the frame buffer 32 on the basis of the address ADM supplied from the MPU 24. Also, in order to store the data DTM supplied from the MPU 24 to the frame buffer 32 on the basis of the write command WRM supplied from the MPU 24, the input/output controller 31 supplies a write command WRA to the frame buffer 32, and stores therein the data DTM as image data DTAW via the OR gate 47.

Similarly, within a time shown in FIG. 6(6), the MPU 24 supplies, to the address controller 37, a chip select signal CSM and an address ADM corresponding to a logical combining data storage region of the frame buffer 34. Also, the MPU 24 supplies, to the input/output controller 31, a write command WRM for requiring the writing of logical combining data to the frame buffer 34, and logical combining data DTM to be stored to the frame buffer 34. Accordingly, the address controller 37 is activated by the chip select signal CSM supplied from the MPU 24, and designate a storage region of the logical combining data to be stored in the frame buffer 34 on the basis of the address ADM supplied from the MPU 24. Also, in order to store the data DTM supplied from the MPU 24 to the frame buffer 34 on the basis of the write command WRM supplied from the MPU 24, the input/output controller 31 supplies a write command WRC to the frame buffer 34, and stores therein the data DTM as logical combining data DTCW via the OR gate 49.

As shown in FIG. 6(3), the input/output controller 31 changes the busy signal ACB from an “L” to an “H” level. Then, in order to prohibit the writing of data to the frame buffers 32-34, the input/output controller 31 supplies an interrupting signal INT having an “H” level writing-prohibiting pulse P₁, to the MPU 24, as shown in FIG. 6(4). The above first frame writing to the frame buffers 32 and 34 by the MPU 24 may also be performed at any point, provided that the busy signal ACB is at “L” level. Also, the input/output controller 31 supplies, to the camera unit 29, a busy signal CB that indicates currently accessing the frame buffer 33, as shown in FIG. 6(2). Also, a frame start signal FS shown in FIG. 6(7) is supplied from the camera unit 29, and its period is 14.2 msec.

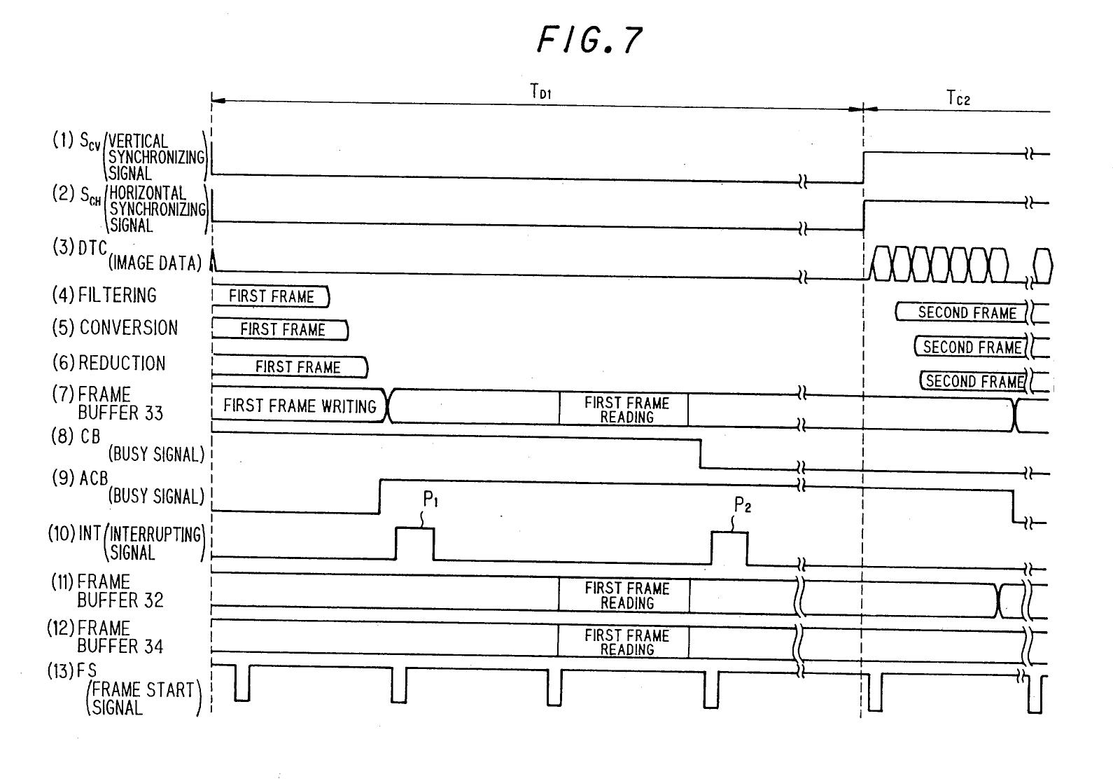

Next, as shown in FIG. 7, within the time T_{D1}, image data DTD transfer to the display unit 28 and the like is performed. The time T_{D1} is equal to a vertical retrace period of a vertical synchronizing signal S_{CV} shown in FIG. 7(1). By performing such a processing, the image data DTC supplied from the camera unit 29 can, substantially in real time, be displayed on the display unit 28. But there is a difference between the transfer rate (about 30 msec) of the image data DTC supplied from the camera unit 29 and the image display rate of the display unit 28 (within 13 msec for the liquid crystal panel display), so that the image data DTC supplied from the camera unit 29 is first written to the frame buffer 33, as described above, because supplying the image data DTC supplied from the camera unit 29 directly to the display can cause various drawbacks such as flickering, blurring due to the difference between the rates of data transfer and image display, and the like. As described above, however, transferring the image data first written to the frame buffer 33 to the display unit 28 within the vertical retrace period of the vertical synchronizing signal S_{CV} can overcome the above drawbacks, while allowing substantially real-time display of the image data DTC supplied from the camera unit 29 on the display.

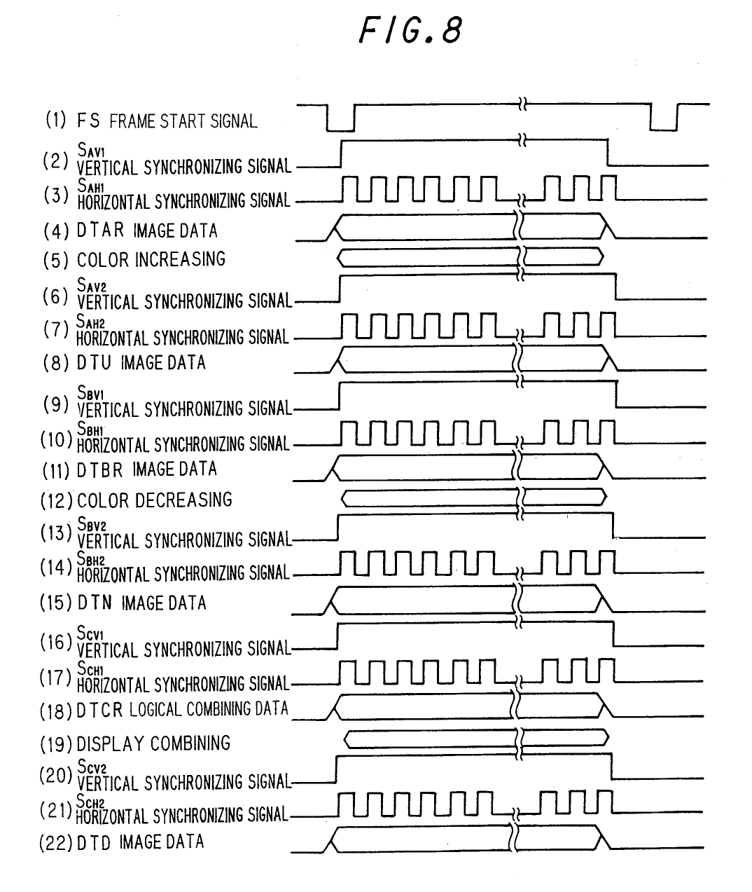

Image data DTD transfer to the display unit 28 and the like will hereinafter be described with reference to FIGS. 7 and 8.

The combining circuit 46 supplies a read command RDC to the input/output controller 31, and an address ADD and a chip select signal CSD to the address controllers 35-37. Accordingly, within a time shown in FIGS. 7(7), 7(11) and 7(12) image data DTAR is read from the frame buffer 32 by 2 bytes/pixel, image data DTBR from the frame buffer 33 by 1 byte/pixel, and logical combining data DTCR from the frame buffer 34 by 1 bit/pixel, substantially at the same time.

Thus, the image data DTAR is supplied to the color increasing circuit 44, the image data DTBR to the color decreasing circuit 45, and the logical combining data DTCR to the combining circuit 46. It is required that data reading from these each frame be performed within 1 period of a frame start signal FS shown in FIG. 7(13), i.e. within 14.2 msec. After that, in order to permit the writing of data to the frame buffers 32-34, the input/output controller 31 supplies an interrupting signal INT having an “H” level writing-permitting pulse P₂, to the MPU 24, as shown in FIG. 7(10).

Also, T_{C2} shown in FIG. 7 denotes a time for which second-frame image data DTC is supplied from the camera unit 29, and its processing is performed in the same manner as the above-described first-frame image data DTC processing. These processings are performed in the same manner on up to the 30th frame supplied from the camera unit 29.

Next, in the color increasing circuit 44, the color decreasing circuit 45 and the combining circuit 46, the following processings are performed within 1 period of a frame start signal FS shown in FIG. 8(1): After being synchronized with a vertical synchronizing signal S_{AV1} shown in FIG. 8(2) and a horizontal synchronizing signal S_{AH1} shown in FIG. 8(3) and being read from the frame buffer 32, image data DTAR shown in FIG. 8(4) is increased in color by the color increasing circuit 44 within a time shown in FIG. 8(5), and then after being synchronized with a vertical synchronizing signal S_{AV2} shown in FIG. 8(6) and a horizontal synchronizing signal S_{AH2} shown in FIG. 8(7), it is supplied to the combining circuit 46 as image data DTU shown in FIG. 8(8). Similarly, after being synchronized with a vertical synchronizing signal S_{BV1} shown in FIG. 8(9) and a horizontal synchronizing signal S_{BH1} shown in FIG. 8(10) and being read from the frame buffer 33, image data DTBR shown in FIG. 8(11) is decreased in color by the color decreasing circuit 45 within a time shown in FIG. 8(12) and then after being synchronized with a vertical synchronizing signal S_{BV2} shown in FIG. 8(13) and a horizontal synchronizing signal S_{BH2} shown in FIG. 8(14), it is supplied to the combining circuit 46 as image data DTN shown in FIG. 8(15). Also, logical combining data DTCR is supplied to the combining circuit 46 as shown in FIG. 8(18).

Accordingly, within a time shown in FIG. 8(19), taking pixel-by-pixel synchronization on the basis of the logical combining data DTCR supplied from the frame buffer 34, the combining circuit 46 combines the image data DTU supplied from the color increasing circuit 44 and the image data DTN supplied from the color decreasing circuit 45, and its combined result is synchronized pixel by pixel with a vertical synchronizing signal S_{CV2} shown in FIG. 8(20) and with a horizontal synchronizing signal S_{CH2} shown in FIG. 8(21), and is supplied to the display unit 28 as image data DTD (see FIG. 8(22)) to be displayed on the display.

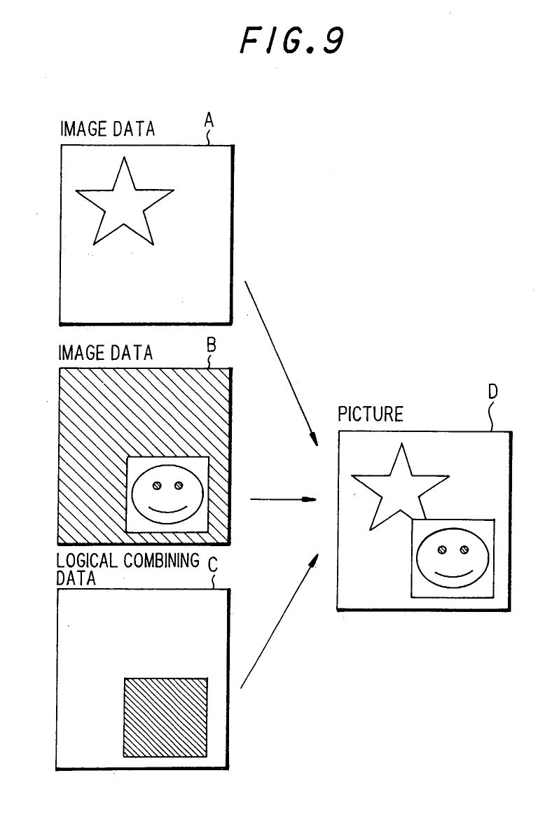

Here, the concept of display combining of this embodiment will be explained with reference to FIG. 9. In FIG. 9, display A is an example of the image data DTU (illustration data in this embodiment) supplied from the MPU 24 and increased in color by the color increasing circuit 44, and display B is an example of the image data DTN (this mobile phone user's face in this embodiment) taken by the camera unit 29 and decreased in color by the color decreasing circuit 45. Also in FIG. 9, display C is an example of the logical combining data DTCR, and display D is an example of the images combined and displayed on the display. In the display B of FIG. 9, the shaded portion represents indeterminate data. In the display C of FIG. 9, the shaded portion designates the image data DTN, i.e. the display B for logic “1” logical combining data DTCR, and the remaining portion designates the image data DTU, i.e. the display A for logic “0” logical combining data DTCR.

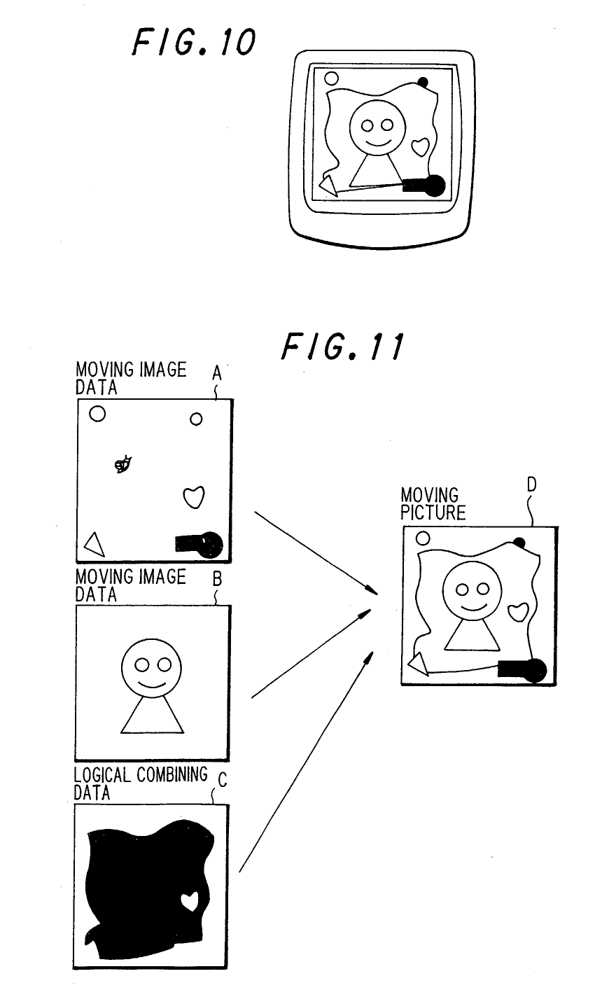

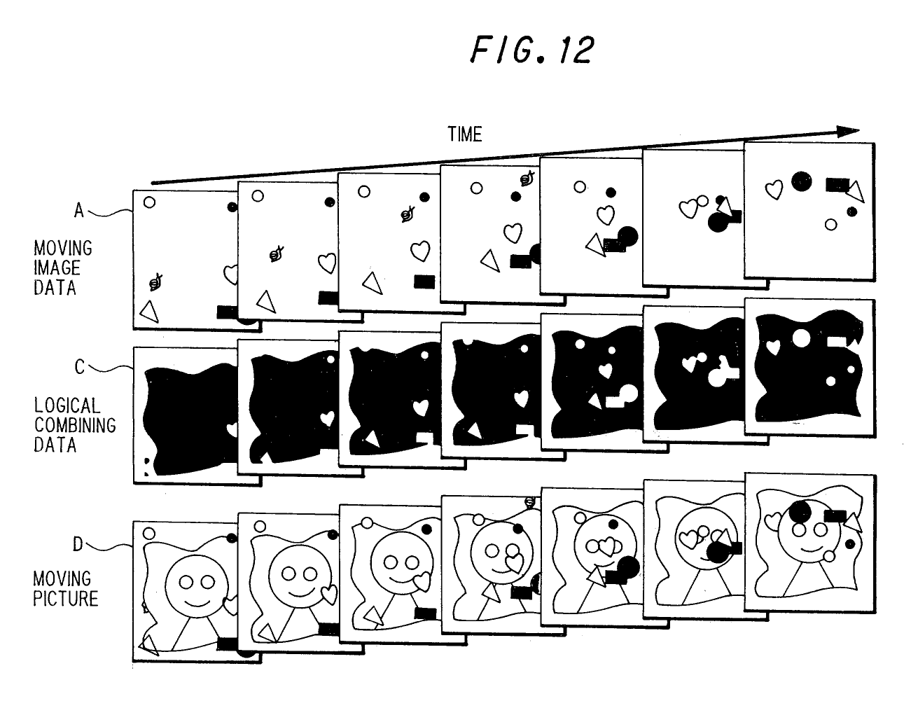

The display combining described above is of static images, but it is similarly true for basic processing of moving images. The concept of display combining of moving images will hereinafter be described with reference to FIGS. 10-12. FIG. 10 is one example of combined moving images displayed on the display. Also, in FIG. 11, display A is an example of the image data DTU (animation data in this embodiment) supplied from the MPU 24 and increased in color by the color increasing circuit 44, and display B is an example of the image data DTN (this mobile phone user's face in this embodiment) taken by the camera unit 29 and decreased in color by the color decreasing circuit 45. Also in FIG. 11, display C is an example of the logical combining data DTCR, and display D is an example of the images combined and displayed on the display. In the display C of FIG. 11, the black-colored portion designates the image data DTN, i. e. the display B for logic “1” logical combining data DTCR, and the remaining portion designates the image data DTU, i.e. the display A for logic “0” logical combining data DTCR. Also, FIG. 12 shows a sequence of the processings shown in FIG. 11 performed with time (left to right).

Further, this embodiment has a function of supplying the image data DTC supplied from the camera unit 29 to the MPU 24 as photographic data. This function will hereinafter be explained. The function is effective when the image data DTC and logic “1” select data SL are supplied from the camera unit 29. First, the filtering circuit 38 performs each kind of filtering described above, such as sepia, brightness adjustment or the like, on the image data DTC, and outputs image data DTCF. Next, the selector 39 supplies the image data DTCF supplied from the filtering circuit 38 to the reduction circuit 41 on the basis of the logic “1” select data SL. Accordingly, the reduction circuit 41 reduces the image data DTCF of YUV form supplied from the selector 39 to image data DTR of the above-described JPEG form, and performs the above-mentioned smart processing thereon.

Next, in order to make the image data DTR supplied from the reduction circuit 41 into the above-described JPEG form, the compression circuit 43 performs specified compression on the image data DTR. Also, in order to store the compressed image data DTJW in a specified storage region of the frame buffers 32-34 treated as a single whole frame buffer, the compression circuit 43 supplies the image data DTJW to the OR gates 47-49 while supplying a write command WRJ to the input/output controller 31, and an address ADJ and a chip select signal CSJ to the address controllers 35-37 treated as a single whole address controller. Accordingly, on the basis of the write command WRJ supplied from the compression circuit 43, the input/output controller 31 permits writing the compressed image data DTJW supplied from the compression circuit 43 to the frame buffers 32-34 via the OR gates 47-49. Also, the address controllers 35-37 are treated as a single whole address controller, and are activated by the chip select signal CSJ supplied from the compression circuit 43, and designate a storage region of image data to be stored in the corresponding frame buffers on the basis of the address ADJ supplied from the compression circuit 43. Accordingly, the frame buffers 32-34 are treated as a single whole frame buffer, and the compressed image data DTJW supplied from the compression circuit 43 is stored. After that, the MPU 24 supplies a read command RDM to the input/output controller 31, and a chip select signal CSM and an address ADM to the address controllers 35-37 treated as a single whole address controller. Thus, the compressed image data DTJW is read from the frame buffers 32-34 treated as a single whole frame buffer, and is supplied via the input/output controller 31 to the MPU 24.

In accordance with the configuration of this embodiment, data buses and address buses, each of which is connected to the frame buffers 32-34, are separate and independent, and signals for controlling the frame buffers 32-34 are also separately and independently suppliable, and the bus interface between the frame buffers 32 and 34 is unitedly or independently and time-sharingly controllable by the MPU 24. Also, the image data DTC supplied from the camera unit 29 is first written to the frame buffer 33, and then is transferred to the display unit 28 within the vertical retrace period of the vertical synchronizing signal S_{CV}. Thus, the image data DTC supplied from the camera unit 29 can, substantially in real time, be displayed on the display unit 28 without causing various drawbacks such as flickering, blurring due to the difference between the rates of data transfer and image display, and the like.

In accordance with the configuration of this embodiment, also, the image display circuitry 21 is comprised of a semiconductor integrated circuit, so that the MPU 24 burden of display combining is small, and no use of MPU with high processing performance and high power consumption is required.

While the embodiment of this invention has been described above with reference to the accompanying drawings, concrete configuration is not limited thereto, and changes and the like in design may be made in the invention without departing from the scope thereof.

While, in the above embodiment, this invention is applied, for example, to a mobile phone, the invention is not limited thereto, and can be applied to other mobile electronic devices such as notebook/palm/pocket computers, PDA, PHS, and the like.

While, in the above embodiment, the illustration data, animation data, and mobile phone user's face taken by the camera unit 29 are combined and displayed, the invention is not limited thereto. This invention can be applied to the case where this mobile phone user's face image and another mobile phone user's face image transmitted from outside are combined and displayed, or to the case where various static and moving image data taken by the camera unit 29, each kind of frame for decorating its periphery, a waiting picture displayed while waiting for incoming data without any operation by a user although with the mobile phone powered on, screen saving pictures displayed for preventing burning in after the waiting picture is displayed for a specified time, and each kind of game picture are combined and displayed. As each kind of frame, there are not only static images but also moving images. As one example of the screen saving pictures, there is an animation pattern, a pattern with which characters that are changed according to season move freely around in the display screen. As one example of each kind of game picture, there is a character raising game for raising selected characters by feeding or cherishing them. Also, as the functions of display combining, there are a telop function for a static or moving image, a wipe function for wiping a picture from one corner and immediately displaying a next picture, and the like. specifically, the telop function is enabled by combining one of the image data DTU and DTN with the other as a telop picture of a static or moving image. Also, the wipe function is enabled by combining one of the image data DTU and DTN with the other as a wipe picture that wipes a picture from one corner and immediately displays a next picture.

While it is also shown in the above embodiment that in order to write and read data to and from any of the frame buffers 32-34, the MPU 24 and the combining circuit 46 supply a write and a read command to the input/output controller 31, the invention is not limited thereto. For example, the MPU 24 and the combining circuit 46 may supply to the input/output controller 31 signals or data that mean requiring the writing and reading of data.

While it is also shown in the above embodiment that the reduction circuit 41 thins out the image data DTCF supplied from the selector 39 every other line and every other pixel in a line so that the height and width of a picture are reduced to ½ and its area is reduced to ¼, and that the reduction circuit 42 thins out the image data DTT supplied from the conversion circuit 40 every other two lines and every other two pixels in a line so that the height and width of a picture are reduced to ¼ and its area is reduced to 1/16, the invention is not limited thereto. In effect, because the reduction circuit 41 may reduce the image data DTCF of YUV form to the image data DTR of JPEG form, and the reduction circuit 42 may reduce the pixel number of the image data DTT supplied from the conversion circuit 40 to the display pixel number of the display, the number of lines and pixels in a line to be thinned out is not limited.

While it is also shown in the above embodiment that when the image data of JPEG form is transferred to the MPU 24, the frame buffers 32-34 are treated as a single frame buffer, the invention is not limited thereto. For example, the frame buffers 32 and 33, frame buffers 33 and 34, or frame buffers 32 and 34 may be treated as a single frame buffer.

As understood from the preferred embodiment of the present invention, those skilled in the art may provide an image display circuitry, which simply comprises a frame buffer, an address controller, an image data processing circuit, data buses and address buses.

In this image display circuitry, those skilled in the art can understand that an image taken by a camera is displayed in real time, even if a frame buffer for storing image data supplied from the MPU and a frame buffer for storing logical combining data are not provided therein.

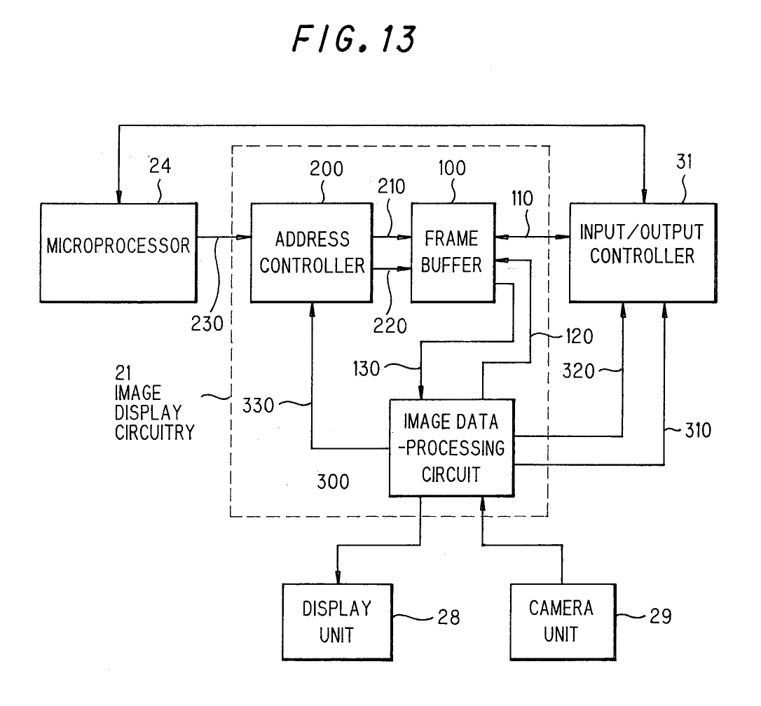

FIG. 13 is a block diagram showing a mobile electronic device in a preferred embodiment of the present invention in which FIG. 13 is illustrated by simplifying FIG. 3 and partially combining FIG. 4 therewith.

In FIG. 13, a frame buffer 100 corresponds to the frame buffers 32-34, an address controller 200 corresponds to the address controllers 35-37, and an image data processing circuit 300 corresponds to the filtering circuit 38, the selector 39, the conversion circuit 40, the reduction circuits 41 and 42, the compression circuit 43, the color increasing circuit 44, the color decreasing circuit 45, and the combining circuit 46, in FIG. 3.

As explained before, the important feature of the present invention is understood in FIG. 13 in which: a data bus 120 for transferring processed image data supplied from the image data processing circuit 300 to the frame buffer 100 is independent of a data bus 110 for transferring image data from the MPU 24 via the input/output controller 31 to the frame buffer 100 and vice versa, and a data bus 130 for transferring image data from the frame buffer 100 to the image data processing circuit 300 is independent of the data bus 110, so that an image is displayed on the display unit 28 in real time in accordance with image data generated by the camera unit 29.

In FIG. 13, a reference numeral 310 is a control bus for a write command for the processed image data supplied from the image data processing circuit 300, and a reference numeral 320 is a control bus for a read command for reading image data from the frame buffer 100. Reference numerals 220 and 330 are address buses for the image data on the data buses 120 and 130, and reference numerals 210 and 230 are address buses for the image data on the data bus 110.

Although the invention has been described with respect to the specific embodiment for complete and clear disclosure, the appended claims are not to be thus limited but are to be construed as embodying all modifications and alternative constructions that may be occurred to one skilled in the art which fairly fall within the basic teaching herein set forth.

What is claimed is:

1. An image display circuitry, comprising:
a first frame buffer for storing first image data;
a second frame buffer for storing second image data supplied from a camera;
a third frame buffer for storing logical combining data to be used for combining said first and second image data pixel by pixel; and
a combining circuit for combining said first and second image data by use of said logical combining data; wherein:
a data bus and an address bus, each of which is connected to said first and third frame buffers, are separate and independent of a data bus and an address bus which are connected to said second frame buffer;
said data bus and said address bus, each of which is connected to said first and third frame buffers, are time-sharingly controllable from outside independently of said data bus and said address bus which are connected to said second frame buffer; and
said first and second image data and said logical combining data are time-sharingly stored and combined in said combining circuit, for one frame within one period of a vertical synchronizing signal for said second image data.

2. An image display circuitry according to claim 1, wherein:
each frame of said second image data is synchronized with a vertical synchronizing signal for said second image data, and stored to said second frame buffer;
each frame of said first image data and said logical combining data is separately and independently stored from outside to said respective first and third frame buffers within a period of storing a corresponding frame of said second image data to said second frame buffer; and
said combining circuit combines, pixel by pixel, said first and second image data read from said respective first and second frame buffers by use of said logical combining data read from said third frame buffer within a specified period during a vertical retrace period of said vertical synchronizing signal.

3. An image display circuitry according to claim 1, wherein said combining circuit combines one of said first and second image data with the other as a telop picture of a static or moving image.

4. An image display circuitry according to claim 1, wherein said combining circuit combines one of said first and second image data with the other as a wipe picture that wipes a picture from one corner and immediately displays a next picture.

5. An image display circuitry according to claim 1, further comprising:
a color increasing circuit for increasing a color of said first image data read from said first frame buffer to a color displayable on a display, and then supplying its processed result to said combining circuit; and
a color decreasing circuit for decreasing a color of said second image data read from said second frame buffer to a color displayable on said display, and then supplying its processed result to said combining circuit.

6. An image display circuitry according to claim 1, further comprising:
a conversion circuit for converting said second image data supplied from said camera into third image data of a form displayable on a display; and
a first reduction circuit for reducing a pixel number of said third image data to a display pixel number of said display.

7. An image display circuitry according to claim 6, wherein said first reduction circuit performs smart processing in reducing said third image data in a line, wherein values of adjacent image data are computed, and its computed result is divided into two.

8. An image display circuitry according to claim 1, further comprising:
a second reduction circuit for reducing said second image data supplied from said camera to fourth image data compressible into image data of JPEG form; and
a compression circuit for compressing said fourth image data into image data of said JPEG form, and then storing it to said first to third frame buffers that are treated as a single whole frame buffer.

9. An image display circuitry according to claim 8, wherein said second reduction circuit performs smart processing in reducing said fourth image data in a line, wherein values of adjacent image data are computed, and its computed result is divided into two.

10. An image display circuitry according to claim 1, further comprising a filtering circuit for performing any one of the following filterings on said second image data supplied from said camera: sepia, brightness adjustment, grey scale, tone binarization, edge enhancement, edge extraction.

11. A mobile electronic device, comprising:
an image display circuitry comprising:
a first frame buffer for storing first image data;
a second frame buffer for storing second image data;
a third frame buffer for storing logical combining data to be used for combining said first and second image data pixel by pixel; and
a combining circuit for combining said first and second image data by use of said logical combining data;
a camera for supplying said second image data to said image display circuitry; and
a display for displaying image data supplied from said image display circuitry, wherein:
a data bus and an address bus, each of which is connected to said first and third frame buffers, are separate and independent of a data bus and an address bus which are connected to said second frame buffer;
said data bus and said address bus, each of which is connected to said first and third frame buffers, are time-sharingly controllable from outside independently of said data bus and said address bus which are connected to said second frame buffer; and
said first and second image data and said logical combining data are time-sharingly stored and combined in said combining circuit, for one frame within one period of a vertical synchronizing signal for said second image data.

12. A mobile electronic device according to claim 11, wherein said first image data is any of: static image data; moving image data; illustration data; animation data; static/moving image data for a frame for decorating a periphery of said second image data; a waiting picture displayed while waiting for incoming data without any operation by a user although with the device powered on; a screen saving picture displayed for preventing burning in after said waiting picture is displayed for a specified time; a game picture.

13. A mobile electronic device according to claim 12, wherein said screen saving picture is an animation pattern, a pattern with which characters that are changed according to season move freely around in a display screen.

14. A mobile electronic device according to claim 12, wherein said game picture is a character raising game for raising selected characters by a user feeding or cherishing them.

15. A mobile electronic device, comprising:
a camera for generating image data to be displayed;
a circuit for processing said image data supplied from said camera to provide processed image data, and generating an address signal to determine a storage address of said processed image data;
a frame buffer for storing said processed image data at said storage address;
a data bus for transferring said processed image data from said processing circuit to said frame buffer; and
a display for displaying an image by use of said processed image data read from said frame buffer.

16. A mobile electronic device according to claim 15, wherein said frame buffer comprises:
a first storage region for storing image data supplied from an MPU;
a second storage region for storing said processed image data; and
a third storage region for storing data to be used for combining said image data read from said first and second storage regions; wherein
said display displays an image obtained from combining said image data read from said first and second storage regions by use of said data read from said third storage region.

17. A mobile electronic device according to claim 15, further comprising a data bus for transferring said image data from said MPU to said first storage region of said frame buffer.

18. A mobile electronic device according to claim 15, wherein said processing circuit comprises:
a filtering circuit for filtering said image data supplied from said camera;
a first reduction circuit for reducing said image data filtered by said filtering circuit to image data compressible into JPEG form; and
a compression circuit for compressing said image data reduced by said first reduction circuit into image data of said JPEG form.

19. A mobile electronic device according to claim 15, wherein said processing circuit comprises:
a filtering circuit for filtering said image data supplied from said camera;
a conversion circuit for converting said image data filtered by said filtering circuit into image data of a form displayable on said display; and
a second reduction circuit for reducing a pixel number of said image data converted by said conversion circuit to a display pixel number of said display.

20. A mobile electronic device according to claim 15, wherein said processing circuit comprises:
a filtering circuit for filtering said image data supplied from said camera;
a first reduction circuit for reducing said image data filtered by said filtering circuit to image data compressible into JPEG form;
a compression circuit for compressing said image data reduced by said first reduction circuit into image data of said JPEG form;
a conversion circuit for converting said image data filtered by said filtering circuit into image data of a form displayable on said display; and
a second reduction circuit for reducing a pixel number of said image data converted by said conversion circuit to a display pixel number of said display.
